(19) United States
(12) Patent Application Publication
(10) Pub. No.: US 2011/0119281 A1
(43) Pub. Date: May 19, 2011

(54) Methods for Discovering Analyst-Significant Portions of a Multi-Dimensional Database

(75) Inventors: Cliff A. Joslyn, Seattle, WA (US); John S. Burke, Kennewick, WA (US); Terence J. Critchlow, Kennewick, WA (US); Emilie Hogan, New Brunswick, NJ (US); Nicolas Hengartner, Los Alamos, NM (US); Judith Cohn, Santa Fe, NM (US)

(73) Assignees: Battelle Memorial Institute; Los Alamos National Security

(21) Appl. No.: 12/775,125

(22) Filed: May 6, 2010

Related U.S. Application Data
(60) Provisional application No. 61/262,403, filed on Nov. 18, 2009.

(51) Int. Cl. G06F 17/30

(52) U.S. Cl. 707/754; 707/E17.059

(57) ABSTRACT

Methods for discovering portions of a multi-dimensional database that are significant to an analyst can be computer-implemented. The methods can include specifying a data view having at least two dimensions and all records of the database. A plurality of operation iterations are then performed on the data view, wherein each iteration is a chain operation, a hop operation or an anti-hop operation. The operation iterations are ceased upon satisfaction of a termination criteria. The resulting data view can then be presented to an analyst. The methods can facilitate a users' knowledge discovery tasks and assist in finding relevant patterns, trends, and anomalies.

### PRIORITY

This invention claims priority from U.S. Provisional Patent Application No. 61/262,403, entitled Methods for Discovering Significant Portions of a Multi-Dimensional Database, filed Nov. 18, 2009.

### STATEMENT REGARDING FEDERALLY SPONSORED RESEARCH OR DEVELOPMENT

This invention was made with Government support under Contract DE-AC0576RL01830 awarded by the U.S. Department of Energy. The Government has certain rights in the invention.

### BACKGROUND

The present invention is related to the field of relational database technology. OLAP technology is commonly attributed with the ability to provide analysts with rapid access to summary, aggregated data views of a single large multi-dimensional database, and is recognized for its ability to provide knowledge representation and discovery in high-dimensional relational databases. OLAP tools can provide intuitive and graphical access to the massively complex set of possible summary views available in large relational structured data repositories. However, the ability to handle such data complexity also presents a wide-ranging, combinatorially vast space of options that can seem impossible to comprehend and/or analyze. Accordingly, there is a need for knowledge discovery techniques that guide users' knowledge discovery tasks and that assist in finding relevant patterns, trends, and anomalies.

### SUMMARY

Embodiments of the present invention address the challenge of navigating a combinatorially vast space of data views of a multi-dimensional database by casting the space of data views as a combinatorial object comprising all projections and subsets and by casting the discovery of analyst-significant data views as a search process over that object. Statistical information theoretical measures are provided with the object and are sufficient to support a combinatorial optimization process. Accordingly, users can be guided, or taken automatically, across a permutation of the dimensions by searching for successive data views having two or more dimensions.

As used herein, a multi-dimensional database comprises a plurality of records with dimensions and is stored on a memory device. An exemplary multi-dimensional database is an online analytical processing (OLAP) database. A data view can refer to a subset of dimensions and data records from a multi-dimensional database and can represent a portion of the database that is significant to an analyst. In some embodiments, the data view comprises at most two dimensions because analysts typically experience difficulty comprehending additional dimensions.

In a particular embodiment of the present invention, the method for discovering portions of a multi-dimensional database that are significant to an analyst is computer-implemented and includes specifying a data view having at least two dimensions and all records of the database. A plurality of operation iterations are then performed on the data view, wherein each iteration is a chain operation, a hop operation or an anti-hop operation. The operation iterations are ceased upon satisfaction of a termination criteria. Examples of the termination criteria can include, but are not limited to, a command from an analyst, a uniform distribution of all remaining records across all remaining dimensions, a lack of remaining dimensions, or a lack of remaining records. The resulting data view can then be presented to an analyst.

A chain operation can comprise calculating a chain statistical significance measure for each value of each of the dimensions in the data view, selecting one or more chain values for a dimension in the view, adding the chain values to a filter, and removing the dimension of the chain values from the view. Exemplary chain statistical significance measures can include, but are not limited to, Hellinger distance, Hellinger distance augmented by p-value significance, relative entropy, and generalized alpha divergence. In some embodiments, the selecting of one or more chain values occurs automatically based on the values having maximal chain statistical significance measures.

A hop operation can comprise calculating a hop statistical significance measure, relative to the dimensions in the view and constrained by the filter, for each of the dimensions that is neither in the data view nor in the filter. The hop operation can further comprise selecting a hop dimension from the dimensions that are not in the view or in the filter and adding the hop dimension to the data view. Exemplary hop statistical significance measures can include, but are not limited to, conditional entropy and model likelihood metric. In some embodiments, the selecting of a hop dimension occurs automatically based on the dimensions having minimal hop statistical significance measures.

An anti-hop operation can comprise calculating an anti-hop statistical significance measure, relative to other dimensions in the view and constrained by the filter, for each of the dimensions in the view. Exemplary anti-hop statistical significance measures can include, but are not limited to, relative entropy. The anti-hop operation can further comprise selecting an anti-hop dimension from the dimensions in the view and removing the anti-hop dimension from the view. In some embodiments, the selecting of an anti-hop dimension occurs automatically based on maximal relative entropy.

In a preferred embodiment, a hop operation and a chain operation are performed in alternating order.

Embodiments of the present invention can be utilized at various degrees of automation for the analyst user. For example, in some embodiments, the data view can be initially populated with dimensions arbitrarily rather than relying on an analyst to specify the initial dimensions. Similarly, prior to performing the plurality of operation iterations, an empty filter can be created and arbitrarily populated with values for a dimension. In another example, while the chain, hop, and anti-hop operations can proceed substantially automatically as describe above, the selection of one or more chain values, the selection of a hop dimension, or the selection of an anti-hop dimension can occur manually based on input from an analyst. When the selections are manual, the chain, hop, and/or anti-hop statistical significance measures can be considered by the analyst or they can be disregarded in favor of the analyst's knowledge or preference.

An analyst guided approach can involve the present invention presenting suggested options, which the analyst can accept or override with manual selections.

The purpose of the foregoing abstract is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

Various advantages and novel features of the present invention are described herein and will become further readily apparent to those skilled in this art from the following detailed description. In the preceding and following descriptions, the various embodiments, including the preferred embodiments, have been shown and described. Included herein is a description of the best mode contemplated for carrying out the invention. As will be realized, the invention is capable of modification in various respects without departing from the invention. Accordingly, the drawings and description of the preferred embodiments set forth hereafter are to be regarded as illustrative in nature, and not as restrictive.

### DESCRIPTION OF DRAWINGS

Embodiments of the invention are described below with reference to the following accompanying drawings.

FIG. 1 is an illustration depicting projection, extension, filtering, and flushing operations as well as an exemplary view operation according to embodiments of the present invention.

FIG. 2 is an illustration depicting the structure 3^{[2]}.

FIG. 3 is a screenshot of a first view of a data set as represented in a data visualization tool.

FIG. 4 is a plot showing the distribution of alarm counts by month.

FIG. 5 is a plot showing frequency distributions of radiation portal monitor (RPM) roles.

FIG. 6 is a plot showing frequency distributions of months.

FIG. 7a is a plot showing Hellinger distances of rows and columns against their marginals

FIG. 7b is a plot showing relative entropy of months against each other significant dimension, given the RPM role=ECCF.

FIG. 8 is a screenshot of a subsequent view on the X²=Months×X³=Day of Month projector. Note the new background filter is RPM Role=ECCF.

### DETAILED DESCRIPTION

The following description includes the preferred best mode of one embodiment of the present invention. It will be clear from this description of the invention that the invention is not limited to these illustrated embodiments but that the invention also includes a variety of modifications and embodiments thereto. Therefore the present description should be seen as illustrative and not limiting. While the invention is susceptible of various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

The following description of the present invention uses a mathematical formalism that is similar to the mathematical tools required to analyze OLAP databases, but is different in a number of ways as well. For example, projections, I, on dimensions and restrictions, J, on records are combined into a lattice-theoretical object called a view, D_{I,J}. Furthermore, OLAP concerns databases organized around collections of variables which can be distinguished as: dimensions, which have a hierarchical structure, and whose Cartesian product forms the data cube's schema; and measures, which can be numerically aggregated within different slices of that schema. The present description considers cubes with a single integral measure, which in some embodiments is the count of a number of records in the underlying database. However, any numerical measure could yield, through appropriate normalization, frequency distributions for use in the view discovery technique of the present invention.

The following examples and description are given in the context of a analyst and/or decision-maker responsible for analyzing a large relational database of records of events of personal vehicles, cargo vehicles, and others passing through radiation portal monitors (RPM) at US ports of entry. In OLAP database methodology, data cubes are multi-dimensional models of an underlying relational database. They are built by identifying a number of dimensions representing categories of interest from the database, each with a possibly hierarchical structure, and then forming their cross-product to represent all possible combinations of values of those dimensions, thus facilitating aggregation of critical quantities over multiple projections of interest. In this example database, the dimensions used included dimensions for multiple time representations, spatial hierarchies of collections of RPMs at different locations, and RPM attributes such as vendor. In this context, a vast collection of different views, focusing on different combinations of dimensions, and different subsets of records, are available to the user.

Operations that can be performed in the view lattice of data tensor cubes can be described according to the following. Let [symbol] ={1, 2, . . . }, [symbol] :={1, 2, . . . , N}. For some N∈ [symbol] , define a data cube as an N-dimensional tensor [symbol] := [symbol] (X, [symbol] , c [symbol] where:
[symbol] :={Xⁱ}ᵢ₌₁^{N} is a collection of N variables or columns with Xⁱ:={xₖ_{ⁱ}}ₖ_{ⁱ}₌₁^{L}^{ⁱ}∈ [symbol] ;
X:=×ₓ_{ⁱ}_{∈} [symbol] Xⁱ is a data space or data schema whose members are N-dimensional vectors x= [symbol] xₖ_{¹}, xₖ_{²}, . . . , xₖN) [symbol] = [symbol] xₖ_{ⁱ} [symbol] ᵢ₌₁^{N}∈X called slots;
c:X→{0, 1, . . . } is a count function.

Let M:=Σ_{x∈X}c(x) be the total number of records in the database. Then [symbol] also has relative frequencies f on the cells, so that f:X→[0,1], where

$$f ( x ) = \frac{c ( x )}{M} ,$$

and thus Σ_{x∈X}f(x)=1. An example of a data tensor with simulated data for our RPM cube is shown in Table 1, for [symbol] ={X¹, X², X³}={RPM Manufacturer, Location, Month}, with RPM Mfr={Ludlum, SAIC}, Location={New York, Seattle, Miami}, and Month={January, February, March, April}, so that N=3. The table shows the counts c(x), so that M=74, and the frequencies f(x).

TABLE 1
An example data tensor involving RPM data. Blank entries repeat
the elements above, and rows with zero counts are suppressed.

| RPM Mfr | Location | Month | c(x) | f(x) |
|---|---|---|---|---|
| Ludlum | New York | Jan | 1 | 0.014 |
| | | Mar | 3 | 0.041 |
| | | Apr | 7 | 0.095 |
| | Seattle | Jan | 9 | 0.122 |
| | | Apr | 15 | 0.203 |
| | Miami | Jan | 2 | 0.027 |
| | | Feb | 8 | 0.108 |
| | | Mar | 4 | 0.054 |
| | | Apr | 1 | 0.014 |
| SAIC | New York | Jan | 1 | 0.014 |
| | Seattle | Feb | 4 | 0.054 |
| | | Mar | 3 | 0.041 |
| | | Apr | 3 | 0.041 |
| | Miami | Jan | 6 | 0.081 |
| | | Feb | 2 | 0.027 |
| | | Mar | 4 | 0.054 |
| | | Apr | 1 | 0.014 |

At any time, it is possible to look at a projection of [symbol] along a sub-cross-product involving only certain dimensions with indices I⊂ [symbol] . Call I a projector, and denote x↓I= [symbol] xₖ [symbol] _{i∈I}∈X↓I, where X↓I:=×_{i∈I}Xⁱ, as a projected vector and data schema. One can write x↓i for x↓{i}, and for projectors I⊂I′ and vectors x, [symbol] ∈X, x↓I⊂ [symbol] ↓I′ is used to mean ∀i∈I, x↓i= [symbol] ↓i.

Count and frequency functions convey to the projected count and frequency functions denoted c[I]: X↓I→ [symbol] and f[I]:X↓I→[0,1], so that

c[I](x↓I)= [symbol] c(x′) (1)

f[I](x↓I)= [symbol] f(x′) (2)

and Σ_{x↓I∈X↓I} f[I](x↓I)=1. In other words, the counts (i.e., resp. frequencies) are added over all vectors in [symbol] ∈X such that [symbol] ↓I=x↓I. This is just the process of building the I-marginal over f, seen as a joint distribution over the Xⁱ for i∈I.

Any set of record indices J⊂ [symbol] is called a filter. Then the filtered count function can be considered c^{J}:X→{0, 1, . . . } and frequency function ƒ^{J}:X→[0,1] whose values are reduced by the restriction in J⊂ [symbol] , now determining

M′:=Σ_{x∈X}c^{J}(x)=|J|≦M. (3)

The frequencies f^{J} can be renormalized over the resulting M′ to derive

$${f}^{J} ( x ) = \frac{{c}^{J} ( x )}{{M}^{′}} , \qquad ( 4 )$$

so that still Σ_{x∈X}f^{J}(x)=1. Finally, when both a selector I and filter J are available, then c^{J}[I]:X↓I→{0, 1, . . . }, f^{J}[I]:x↓I→[0,1] defined analogously, where now Σ_{x↓∈X↓I}f^{J}[I](x↓I)=1. Given a data cube [symbol] , denote [symbol] as a view of [symbol] , restricting attention to just the J records projected onto just the I dimensions X↓I, and determining counts c^{J}[I] and frequencies f^{J}[I].

In a lattice theoretical context, each projector I⊂ [symbol] can be cast as a point in the Boolean lattice B^{N} of dimension N called a projector lattice. Similarly, each filter J⊂ [symbol] is a point in a Boolean lattice B^{M} called a filter lattice. Thus each view [symbol] maps to a unique node in the view lattice [symbol] := [symbol] × [symbol] =2^{N}×2^{M}, the Cartesian product of the projector and filter lattices.

Operations on data views can then be defined as transitions from an initial view [symbol] to another [symbol] or [symbol] , corresponding to a move in the view lattice B:

Projection: Removal of a dimension so that I′=I^{\}{i} for some i∈I. This corresponds to moving a single step down in [symbol] , and to marginalization in statistical analyses. This results in ∀x′↓I′∈X↓I′,

c^{J}[I′](x′↓I′)=Σ_{x↓I⊃x′↓I′}c^{J}[I](x). (5)

This is also identified as an “anti-hop” operation.

Extension: Addition of a dimension so that I′=I∪{i} for some i∉I. This corresponds to moving a single step up in [symbol] , which results in a desegregating or distributing of information about the I dimensions over the I′^{\}I dimensions. Notationally, this is the converse of (5), so that ∀x↓I∈X↓I,

Σ_{x′↓I′⊃x↓I}c^{J}[I′](x′)=c^{J}[I](x↓I).

This is also identified as a “hop” operation.

Filtering: Removal of records by strengthening the filter, so that J′⊂J. This corresponds to moving potentially multiple steps down in [symbol] .

Flushing: Addition of records by weakening (reversing, flushing) the filter, so that J′⊃J. This corresponds to moving potentially multiple steps up in [symbol] .

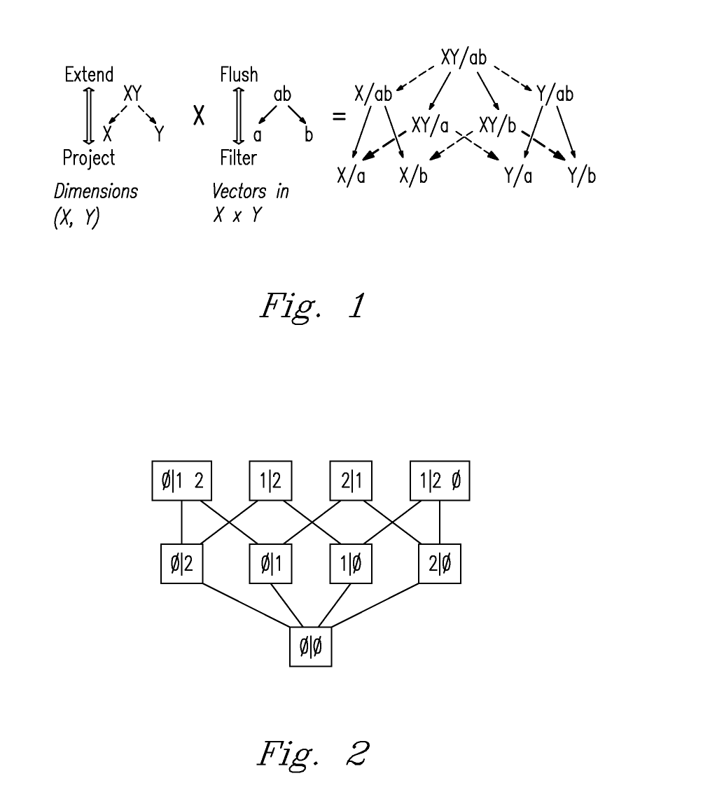

Repeated view operations thus map to trajectories in B. Consider the example shown in FIG. 1 for N=M=2 with dimensions [symbol] ={X,Y} and two N-dimensional data vectors a,b∈X×Y, and denote e.g. X/ab={a↓{X}, b↓{X}}. The left side of FIG. 1 shows the separate projector and selector lattices (bottom nodes φ not shown), with extension as a transition to a higher rank in the lattice and projection as a downward transition. Similarly, filtering and flushing are the corresponding operations in the filter lattice. The view lattice is shown on the right, along with a particular view operation [symbol] , which projects the subset of records {a} from the two-dimensional view {X,Y}= [symbol] to the one-dimensional view {X}⊂ [symbol] .

Regarding relational expressions and background filtering, typically M>>N, so that there are far more records than dimensions (in the present example, M=74 >3=N). In principle, filters J defining which records to include in a view can be specified arbitrarily, for example through any SQL or MDX where clause, or through OLAP operations like top n, including the n records with the highest value of some feature. In practice, filters are specified as relational expressions in terms of the dimensional values, as expressed in MDX where clauses. An example of a filter can include where RPM Mfr=“Ludlum” and (Month<=“February” and Month>=“January”), using chronological order on the Month variable to determine a filter J specifying just those 20 out of the total possible 74 records. For notational purposes, sometimes these relational expressions will be used to indicate the corresponding filters.

Note that each relational filter expression references a certain set of variables, in this case RPM Mfr and Month, denoted as R⊂ [symbol] . Compared to the projector I, R naturally divides into two groups of variables:

Foreground: Those variables in R^{f}:=R∩I which appear in both the filter expression and are included in the current projection.

Background: Those variables in R^{b}:=R^{\}I which appear only in the filter expression, but are not part of the current projection.

The portions of filter expressions involving foreground variables restrict the rows and columns displayed in the OLAP tool. Filtering expressions can have many sources, such as Show Only or Hide. It is common in full (hierarchical) OLAP to select a collection of siblings within a particular sub-branch of a hierarchical dimension. For example for a spatial dimension, the user within an OLAP database software system, such as ProClarity, might select All→USA→California, or its children California→Cities, all siblings. But those portions of filter expressions involving background variables do not change which rows or columns are displayed, but only serve to reduce the values shown in cells. In ProClarity, these are shown in the Background pane.

### EXAMPLE

Table 2 shows the results of four view operations from the example data in Table 1, including a projection I={1,2,3} [symbol] I′={1,2}, a filter using relational expressions, and a filter using a non-relational expression. Table 2d shows a hybrid result of applying both the projector I′={1,2} and the relational filter expression where RPM Mfr=“Ludlum” and (Month<=“February” and Month>=“January”). Compare this to Table 2a, where there is only a quantitative restriction for the same dimensionality because of the use of a background filter. Here I={RPM Mfr, Location}, R={RPM Mfr, Month}, R^{f}={RPM Mfr}, R^{b}={Month}, M′=20.

Table 2a

| RPM Mfr | Location | c[I′](x) | f[I′](x) |
|---|---|---|---|
| Ludlum | New York | 11 | 0.150 |
| | Seattle | 24 | 0.325 |
| | Miami | 15 | 0.203 |
| SAIC | New York | 1 | 0.014 |
| | Seattle | 10 | 0.136 |
| | Miami | 13 | 0.176 |

Table 2b

| RPM Mfr | Location | Month | c^{J}′(x) | f^{J}′(x) |
|---|---|---|---|---|
| Ludlum | New York | Jan | 1 | 0.050 |
| | Seattle | Jan | 9 | 0.450 |
| | Miami | Jan | 2 | 0.100 |
| | | Feb | 8 | 0.400 |

Table 2c

| RPM Mfr | Location | Month | c^{J}′(x) | f^{J}′(x) |
|---|---|---|---|---|
| Ludlum | Seattle | Apr | 15 | 0.333 |
| | | Jan | 9 | 0.200 |
| | Miami | Feb | 8 | 0.178 |
| | New York | Apr | 7 | 0.156 |
| SAIC | New York | Jan | 6 | 0.133 |

Table 2d

| RPM Mfr | Location | c^{J}′[I′](x) | f^{J}′[I′](x) |
|---|---|---|---|
| Ludlum | New York | 1 | 0.050 |
| | Seattle | 9 | 0.450 |
| | Miami | 10 | 0.500 |

Table 2a-2d: Results from view operations [symbol] from the data cube in Table 1. Projection: (Table 2a) I′ = {1, 2}, M′ = M = 74. (Table 2b) Filter: J′ = where RPM Mfr = “Ludlum” and (Month <= “Feb” and Month >= “Jan”), M′ = 20. (Table 2c) Filter: J′ determined from top 5 most frequent entries, M′ = 45. (Table 2d) I′ = {1, 2} and J′ determinued by the relational expression where RPM Mfr = “Ludlum” and (Month <= “Feb” and Month >= “Jan”), M′ = 20.

In some instances, the filter J is fixed and the superscript on f is suppressed. The frequencies f:X→[0,1] represent joint probabilities f(x)=f(xₖ_{¹}, xₖ_{²}, . . . , xₖ_{^{N}}), so that from (2) and (5), f[I](x↓I) expresses the I-way marginal over a joint probability distribution f. Now consider two projectors I₁,I₂⊂ [symbol] , so that a conditional frequency f[I₁|I₂]:X↓I₁∪I₂→[0,1] where

$$f [ {I}_{1} \vert {I}_{2} ] := \frac{f [ {I}_{1} ⋃ {I}_{2} ]}{f [ {I}_{2} ]}$$

can be defined. Individual vectors can be described as follows.

$$f [ {I}_{1} \vert {I}_{2} ] ( x ) = f [ {I}_{1} \vert {I}_{2} ] ( x ↓ {I}_{1} ⋃ {I}_{2} ) := \frac{f [ {I}_{1} ⋃ {I}_{2} ] ( x ↓ {I}_{1} ⋃ {I}_{2} )}{f [ {I}_{2} ] ( x ↓ {I}_{2} )} .$$

f[I₁|I₂](x) is the probability of the vector x↓I₁∪I₂ restricted to the I₁∪I₂ dimensions given that it is known that one can only choose vectors whose restriction to I₂ is x↓I₂. Note that f[I₁|φ](x)=f[I₁](x),f[φ|I₂]≡1, and since f[I₁|I₂]=f[I₁^{\}I₂|I₂], in general assume that I₁ and I₂ are disjoint.

The concept of a view can then be extended to a conditional view [symbol] as a view on [symbol] , which is further equipped with the conditional frequency f^{J}[I₁|I₂]. Conditional views [symbol] live in a different combinatorial structure than the view lattice [symbol] . Describing I₁|I₂ and J in a conditional view requires three sets I₁,I₂∈ [symbol] and J∈ [symbol] with I₁ and I₂ disjoint. So define [symbol] :=3^{[N]}×2^{M} where 3^{[N]} is a graded poset with the following structure:
N+1 levels numbered from the bottom 0, 1, . . . N.
The i^{th} level contains all partitions of each of the sets in

$$( \begin{matrix}[ N ] \\ i\end{matrix} ) ,$$

that is the i-element subsets of [symbol] , into two parts where
1. The order of the parts is significant, so that [{1,3}, {4}] and [{4}, {1,3}] of {1,3,4} are not equivalent.
2. The empty set is an allowed member of a partition, so [{1,3,4},φ] is in the third level of 3^{[N]} for N≧4.
The two sets are written without set brackets and with a | separating them.
The partial order is given by an extended subset relation: if I₁⊂I′₁ and I₂⊂I′₂, then I₁|I₂ [symbol] I′₁|I′₂, e.g. 1 2|3 [symbol] 1 2 4|3.

An element in the poset 3^{[N]} corresponds to an I₁|I₂ by letting I₁ (resp. I₂) be the elements to the left (resp. right) of the |. This poset is called 3^{[N]} because it's size is 3^{N} and it really corresponds to partitioning [symbol] into three disjoint sets, the first being I₁, the second being I₂ and the third being [symbol] ^{\}(I₁∪I₂). The structure 3^{[2]} is shown in FIG. 2.

For a view [symbol] ∈B, which is identified with its frequency f^{J}[I], or a conditional view [symbol] ∈A, which is identified with its conditional frequency f^{J}[I₁|I₂], the aim is measuring how “interesting” or “unusual” it is, as measured by departures from a null model. Such measures can be used for combinatorial search over the view structures B, A to identify noteworthy features in the data. The entropy of an unconditional view D_{I,J}

H(f^{J}[I]):=−Σ_{x∈X↓I}f^{J}[I](x)log(f^{J}[I](x)).

is a well-established measure of the information content of that view. A view has maximal entropy when every slot has the same expected count. Given a conditional view [symbol] , we define the conditional entropy, H(f^{J}[I₁|I₂]) to be the expected entropy of the conditional distribution f^{J}[I₁|I₂], which operationally is related to the unconditional entropy as

H(f^{J}[I₁|I₂]):=H(f^{J}[I₁∪I₂])−H(f^{J}[I₂]).

Given two views [symbol] of the same dimensionality I, but with different filters J and J′, the relative entropy (Kullback-Leibler divergence)

$$D ( {f}^{J} [ I ] ‖ {f}^{{J}^{′}} [ I ] ) := {\sum }_{x ∈ X ↓ I}^{ } {f}^{J} [ I ] ( x ) log ( \frac{{f}^{J} [ I ] ( x )}{{f}^{{J}^{′}} [ I ] ( x )} )$$

is a well-known measure of the similarity of f^{J}[I] to f^{J′}[I]. D is zero if and only if f^{J}[I]=f^{J′}[I], but it is not a metric because it is not symmetric, i.e., D(f^{J}[I]∥f^{J′}[I])≠D(f^{J′}[I]∥f^{J}[I]).

D is a special case of a larger class of a-divergence measures between distribution. Given two probability distributions P and Q, write the density with respect to the dominating measure μ=P=Q as p=dP/d(P+Q) and q=dQ/d(P+Q). For any a∈ [symbol] , the a-divergence is

$${D}_{α} ( P ‖ Q ) = \int \frac{ap ( x ) + ( 1 - α ) q ( x ) - {p ( x )}^{α} {q ( x )}^{1 - α}}{α ( 1 - α )} μ ( d x ) .$$

a-divergence is convex with respect to both p and q, is non-negative, and is zero if and only p=q μ-almost everywhere. For a≠0,1, the a-divergence is bounded. The limit when a→1 returns the relative entropy between P and Q. There are other special cases that are of interest to us:

$${D}_{2} ( P ‖ Q ) = \frac{1}{2} \int \frac{{( p ( x ) - q ( x ) )}^{2}}{q ( x )} μ ( d x ) \\ {D}_{- 1} ( P ‖ Q ) = \frac{1}{2} \int \frac{{( q ( x ) - p ( x ) )}^{2}}{p ( x )} μ ( d x ) \\ {D}_{1 / 2} ( P ‖ Q ) = 2 \int {( \sqrt{p ( x )} - \sqrt{q ( x )} )}^{2} μ ( d x ) .$$

In particular the Hellinger metric \sqrt{D_{1/2}} is symmetric in both p and q, and satisfies the triangle inequality. We prefer the Hellinger distance over the relative entropy because it is a bonified metric and remains bounded. In our case and notation, we have the Hellinger distance as

$$G ( {f}^{J} [ I ] , {f}^{{J}^{′}} [ I ] ) := \sqrt{{\sum }_{x ∈ X ↓ I}^{ } {( \sqrt{{f}^{J} [ I ] ( x )} - \sqrt{{f}^{{J}^{′}} [ I ] ( x )} )}^{2}} .$$

### Example: Hop-Chain View Discovery

Based on the data views, conditional views, and information measures described herein, a variety of user-guided, and/or automated, navigational tasks can be embodied by the present invention. For example, “drill-down paths” can be described as creating a series of views with projectors I₁⊃I₂⊃I₃ of increasingly specified dimensional structure. In practice, many analysts are challenged by complex views of high dimensionality, while still needing to explore many possible data interactions. Accordingly, embodiments of the present invention can restrict analysts to two-dimensional views only, producing a sequence of projectors I₁, I₂, I₃ where |Iₖ|=2 and |Iₖ∩Iₖ₊₁|=1, thus affecting a permutation of the variables Xⁱ.

An arbitrary permutation of the i∈ [symbol] can be assumed so that one can refer to the dimensions X¹, X², . . . , X^{N} in order. The choice of the initial variables X¹, X² is a free parameter to the method, acting as a kind of “seed”.

One thing that is critical to note is the following. Consider a view [symbol] which is then filtered to include only records for a particular member x₀ⁱ^{₀}∈Xⁱ^{₀} of a particular dimension Xⁱ^{₀}∈ [symbol] ; in other words, let J′ be determined by the relational expression where Xⁱ^{₀}=x₀ⁱ^{₀}. Then in the new view [symbol] f^{J′}[I] is positive only on the fibers of the tensor X where Xⁱ^{₀}=x₀ⁱ^{₀}, and zero elsewhere. Thus the variable Xⁱ^{₀} is effectively removed from the dimensionality of [symbol] , or rather, it is removed from the support of [symbol] .

Notationally, it can be said that [symbol] = [symbol] Under the normal convention that 0·log(0)=0, information measures H and G above are insensitive to the addition of zeros in the distribution. This allows for a comparison of the view [symbol] to any other view of dimensionality I^{\}{i₀}.

This is illustrated in Table 3 through the continuing example, now with the filter where Location=“Seattle”. Although formally still an RPM Mfr×Location×Month cube, in fact this view lives in the RPM Mfr×Month plane, and so can be compared to the RPM Mfr×Month marginal.

TABLE 3
Our example data tensor from Table 1 under
the filter where Location = “Seattle”; M′ = 34

| RPM Mfr | Location | Month | c(x) | f(x) |
|---|---|---|---|---|
| Ludlum | Seattle | Jan | 9 | 0.265 |
| | | Apr | 15 | 0.441 |
| SAIC | | Feb | 4 | 0.118 |
| | | Mar | 3 | 0.088 |
| | | Apr | 3 | 0.088 |

Finally, some caution is necessary when the relative entropy D(f^{J}[I]∥f^{J′}[I]) or Hellinger distance G(f^{J}[I],f^{J′}[I]) is calculated from data, as their magnitudes between empirical distributions is strongly influenced by small sample sizes. To counter spurious effects, in preferred embodiments, each calculated entropy can be supplemented with the probability that under the null distribution that the row has the same distribution as the marginal, of observing an empirical entropy larger or equal to actual value. When that probability is large, say greater than 5%, then its value can be considered spurious and be set to zero before proceeding with the algorithm.

In the instant example, a hop operation and a chain operation can be performed in alternating order (i.e., a hop-chain operation). One way of performing the hop-chain view discovery can be performed as described below.

1. Set the initial filter to J= [symbol] . Set the initial projector I={1,2}, determining the initial view f^{J}[I] as just the initial X¹×X² grid.

2. For each row xₖ_{¹}∈X¹, the marginal distribution is f^{X}^{¹}^{x}^{ₖ}¹[I] of that individual row, using the superscript to indicate the relational expression filter. Also, the marginal f^{J}[I^{\}{X¹}] over all the rows for the current filter J is known. In light of the discussion just above, all the Hellinger distances can be calculated between each of the rows and this row marginal as

G(f^{X}^{¹}^{x}^{ₖ}¹[I],f^{J}[I^{\}{X¹}])=G(f^{X}^{¹}^{=x}^{ₖ}¹[I^{\}{X¹}],f^{J}[I^{\}{X¹}]),

and retain the maximum row value G¹:=maxₓ_{ₖ}_{1∈X}_{¹}G(f^{X}^{¹}^{=x}^{ₖ}¹[I],f^{J}[I^{\}{X¹}]). It can be dually done so for columns against the column marginal:

G(f^{X}^{²}^{x}^{ₖ}²[I],f^{J}[I^{\}{X²}])=G(f^{X}^{²}^{=x}^{ₖ}²[I^{\}{X²}],f^{J}[I^{\}{X²}]),

retaining the maximum value G²:=maxₓ_{ₖ}_{22∈X}_{²}G(f^{X}^{²}^{=x}ₖ²[I],f^{J}[I^{\}{X²}]).

3. The user can be prompted to select either a row x₀¹∈X¹ or a column x₀²∈X². Since G¹ (resp. G²) represents the row (column) with the largest distance from its marginal, selecting the global maximum max(G¹, G²) might be most appropriate; or this can be selected automatically. Letting x′₀, be the selected value from the selected variable (row or column) i′∈I, then J′ is set to where X^{i′}=x′₀, and this is placed in the background filter.

4. Let i″∈I be the variable not selected by the user, so that I={i′,i″}.

5. For each dimension i′″∈ [symbol] ^{\}I, that is, for each dimension which is neither in the background filter R^{b}={i′} nor retained in the view through the projector {i″}, calculate the conditional entropy of the retained view f^{J′}[{i″}] against that variable: H(f^{J′}[{i″}|{I′″}]).

6. The user is prompted to select a new variable i′″∈ [symbol] ^{\}I to add to the projector {i″}. Since

$${argmin}_{{i}^{′′′} ∈ {ℕ}_{N} \backslash I} H ( {f}^{{J}^{′}} [ \{ {i}^{′′} \} \vert \{ {i}^{′′′} \} ] )$$

represents the variable with the most constraint against i″, that may be the most appropriate selection, or it can be selected automatically.

7. Let I′={i″,i′″}. Note that I′ is a sibling to I in [symbol] , thus the name “hop-chaining”.

8. Let I′,J′ be the new I,J and go to step 2.

Keeping in mind the arbitrary permutation of the Xⁱ, then the repeated result of applying this method is a sequence of hop-chaining steps in the view lattice, building up an increasing background filter:

I={1,2},J= [symbol] 1

I′={2,3},J′=where X¹=x₀¹ 2.

I″={3,4},J″=where X¹=x₀¹,X²=x₀² 3.

I′″={4,5},J′″=where X¹=x₀¹,X²=x₀²,X³=x₀³ 4

In a particular example of the hop-chain operation, ProClarity® is used in conjunction with SQL Server Analysis Services (SSAS) 2005 and the R statistical platform v. 2.7 (see http://www.r-project.org). ProClarity® is a visual analytics tool that provides a flexible and friendly GUI environment with extensive API support which is used to gather current display contents and query context for row, column and background filter selections. R is currently used in either batch or interactive mode for statistical analysis and development. Microsoft Visual Studio .Net 2005® is used to develop plug-ins to ProClarity® to pass ProClarity® views to R for hop-chain calculations.

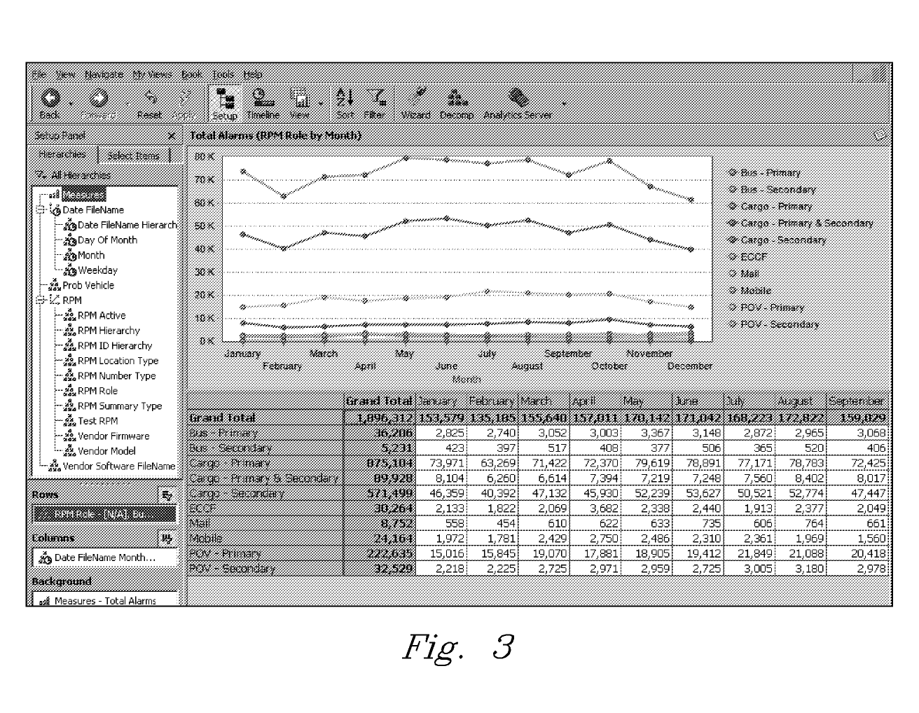

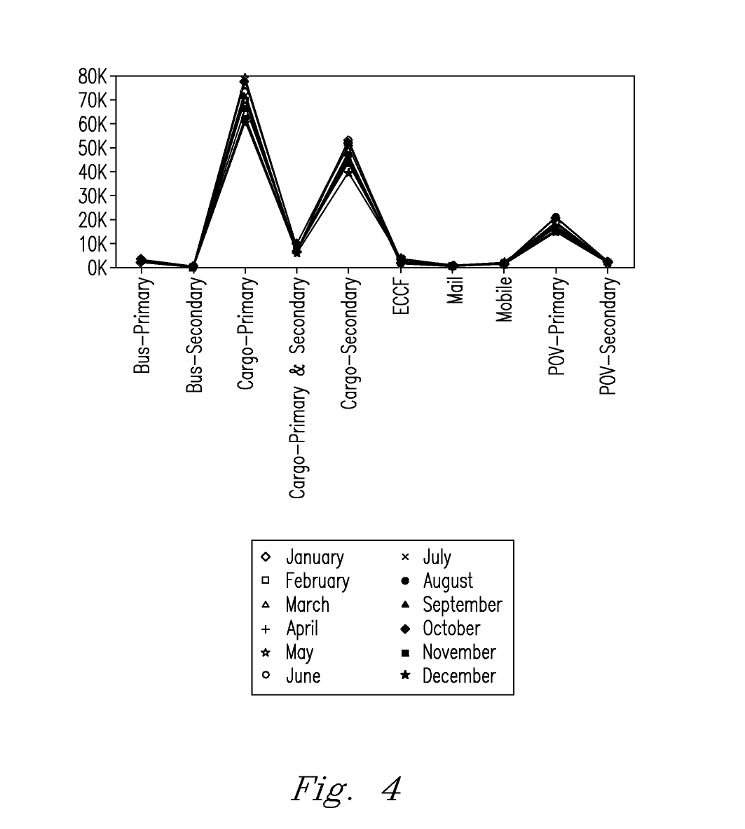

A first view of the data set used in the instant example is shown in FIG. 3, which is a screenshot from the ProClarity® tool. The database is a collection of 1.9M records of RPM events. The 15 available dimensions are shown on the left of the screen (e.g. “day of the month”, “RPM hierarchy”), tracking such things as the identities and characteristics of particular RPMs, time information about events, and information about the hardware, firmware, and software used at different RPMs.

For purposes of this description, only a single step for the hop-chaining procedure against the alarm summary data cube is shown.

FIG. 3 shows the two-dimensional projection of the X¹=“RPM Role”×X²=“Month” dimensions within the 15-dimensional overall cube, drilled down to the first level of the hierarchies. Its plot shows the distributions of count c of alarms by RPM role (Busses Primary, Cargo Secondary, etc.) X¹, while FIG. 4 shows the distribution by Month X².

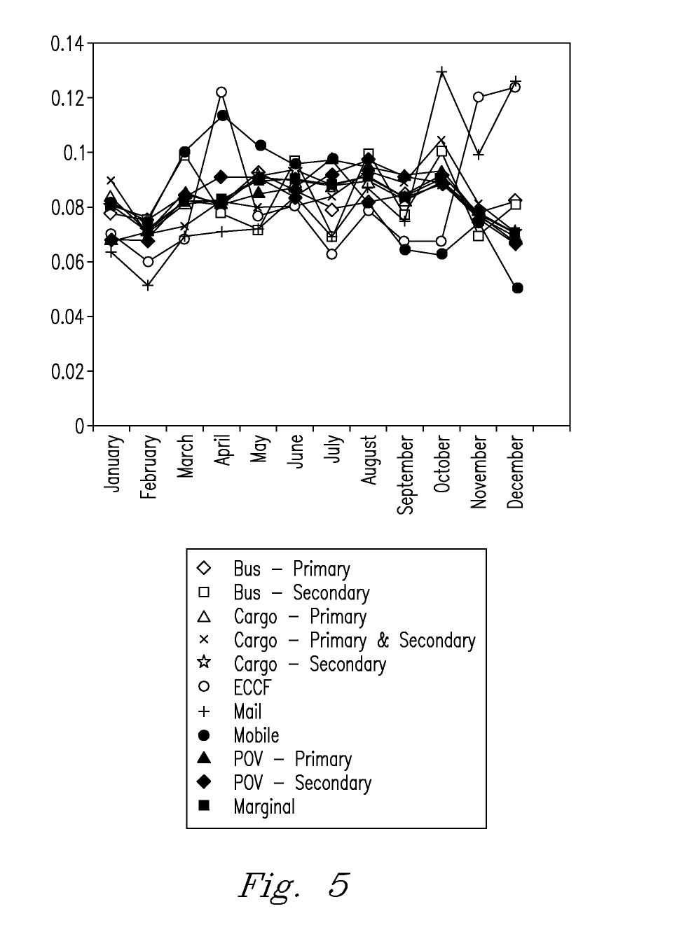

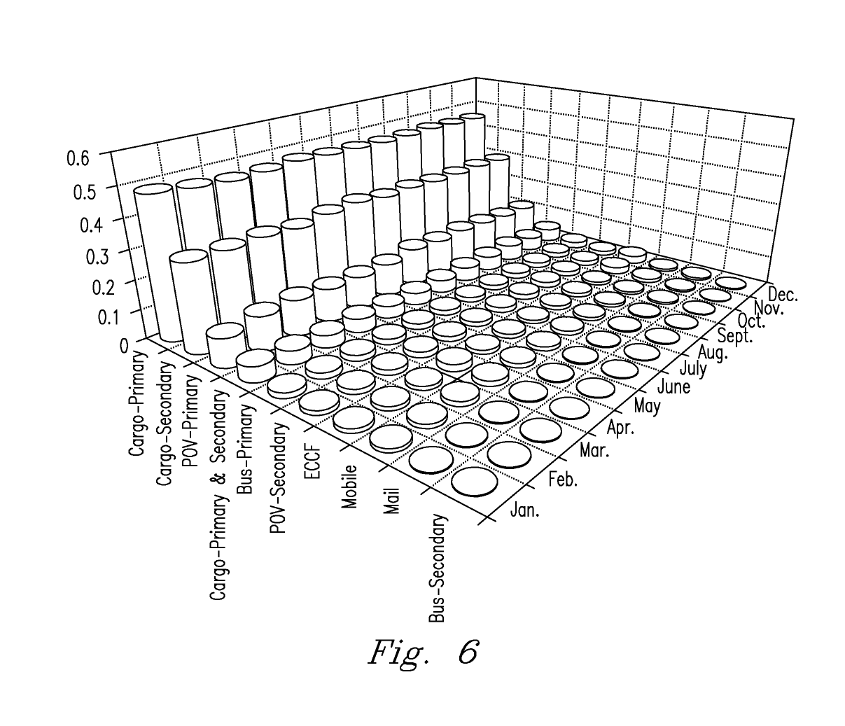

The distributions for roles seem to vary at most by overall magnitude, rather than shape, while the distributions for months appear almost identical. However, FIG. 5 and FIG. 6 show the same distributions, but now in terms of their frequencies f relative to their corresponding marginals, allowing a comparison of the shapes of the distributions normalized by their absolute sizes. While the months still seem identical, the RPM roles are clearly different, although it is difficult to discern which one is most unusual with respect to the marginal (bold line).

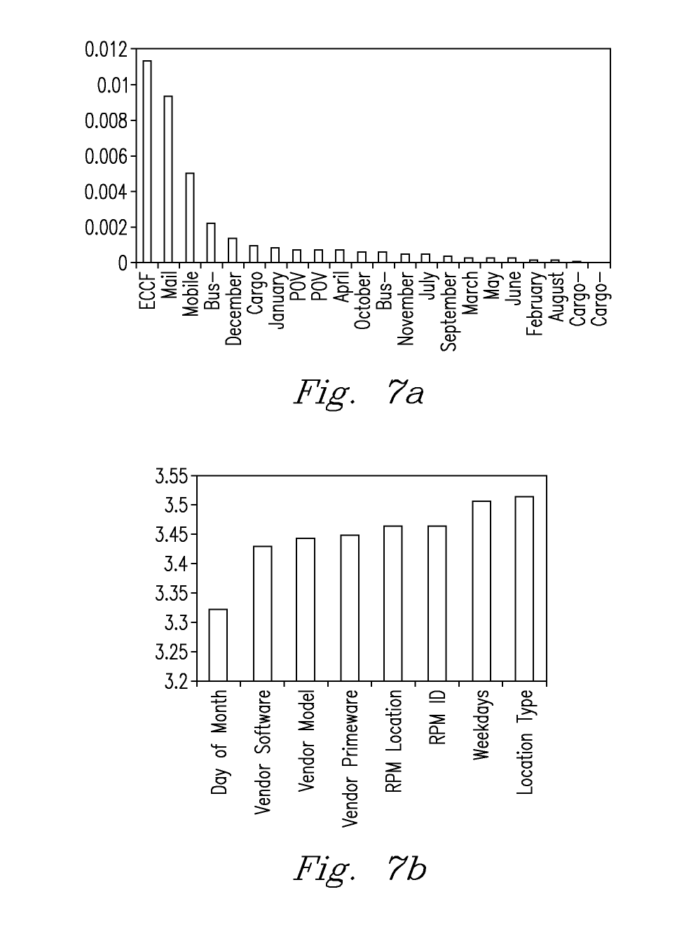

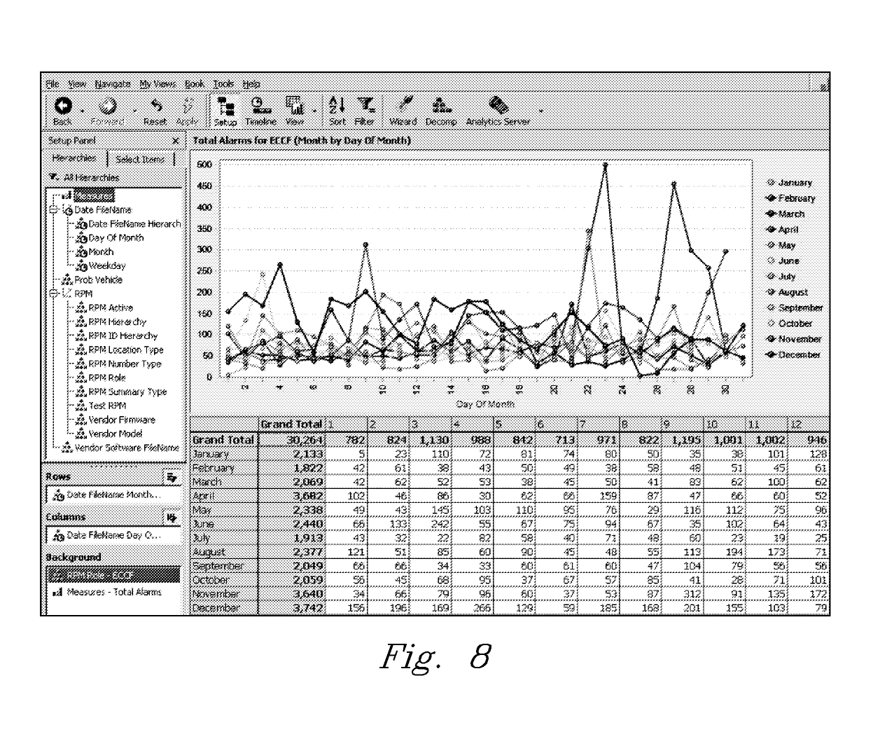

FIG. 7a shows the Hellinger distances G(f^{x}^{ⁱ}^{=x}^{ₖ}ⁱ[I],f^{J}[I^{\}{Xⁱ}]) for i∈{1,2} for each row or column against its marginal. The RPM roles “ECCF” and “Mail” are clearly the most significant, which can be verified by examining the anomolously shaped plots in FIG. 5. The most significant month is December, although this is hardly evident in FIG. 6. The maximal row-wise Hellinger value, G¹=0.011, is selected for ECCF so that i′=1,x₀¹=ECCF. X^{i′}=X¹=“RPM Role” is added to the background filter, X^{i″}=X²=Months is retained in the view, and H(f^{J′}[{2}|{i′″}]) is calculated for all i′″∈{3, 4, . . . , 15}, which are shown in FIG. 7b for all significant dimensions. On that basis, X³ is selected as Day of Month with minimal H=3.22.

The subsequent view for X²=Months×X³=Day of Month is then shown in FIG. 8. Note the strikingly divergent plot for April: it in fact does have the highest Hellinger distance at 0.07, an aspect which is completely invisible from the overall initial view, e.g. in FIG. 5.

While a number of embodiments of the present invention have been shown and described, it will be apparent to those skilled in the art that many changes and modifications may be made without departing from the invention in its broader aspects.

We claim:

1. A computer-implemented method for discovering portions of a multi-dimensional database that are significant to an analyst, wherein the multi-dimensional database comprises a plurality of records with dimensions and is stored on a memory device, the method characterized by the steps of:
Specifying a data view comprising at least two dimensions and all records of the database;
Performing a plurality of operation iterations on the data view, wherein each iteration is a chain operation, a hop operation, or an anti-hop operation;
Ceasing said operation iterations upon satisfaction of a termination criteria; and
Presenting to the analyst the data view resulting from said performing;
Wherein the chain operation comprises the steps of:
Calculating a chain statistical significance measure for each value of each of the dimensions in the data view;
Selecting one or more chain values for a dimension in the view;
Adding the chain values to a filter;
Removing the dimension of the chain values from the view;
Wherein the hop operation comprises the steps of:
Calculating a hop statistical significance measure, relative to the dimension(s) in the view and constrained by the filter, for each of the dimensions that is neither in the view nor in the filter;
Selecting a hop dimension from the dimensions that are not in the view or in the filter;
Adding the hop dimension to the data view; and
Wherein the anti-hop operation comprises the steps of:
Calculating an anti-hop statistical significance measure relative to other dimensions in the view and constrained by the filter, for each of the dimensions in the view;
Selecting an anti-hop dimension from the dimensions in the view; and
Removing the anti-hop dimension from the view.

2. The method of claim 1, wherein the chain statistical significance measure is a Hellinger distance.

3. The method of claim 1, wherein the chain statistical significance measure is a Hellinger distance augmented by p-value significance.

4. The method of claim 1, wherein the chain statistical significance measure is a relative entropy.

5. The method of claim 1, wherein the chain statistical significance measure is a generalized alpha divergence.

6. The method of claim 1, wherein the hop statistical significance measure is a conditional entropy measure.

7. The method of claim 1, wherein the hop statistical significance measure is a model likelihood metric.

8. The method of claim 1, wherein said selecting one or more chain values for a dimension in the view occurs automatically based on the values having maximal chain statistical significance measures.

9. The method of claim 1, wherein said selecting a hop dimension occurs automatically based on the dimensions having minimal hop statistical significance measures.

10. The method of claim 1, wherein said selecting one or more chain values, said selecting a hop dimension, or both occur manually based on input from an analyst.

11. The method of claim 1, wherein the termination criteria is a command from an analyst, a uniform distribution of all remaining records across all remaining dimensions, a lack of remaining dimensions, or a lack of remaining records.

12. The method of claim 1, further comprising performing hop and chain operations in alternating order.

13. The method of claim 1, wherein the data view is initially populated with dimensions arbitrarily.

14. The method of claim 1, prior to said performing, further comprising creating an empty filter and arbitrarily populating the empty filter with values for a dimension.

15. The method of claim 1, wherein the data view comprises two dimensions.

16. The method of claim 1, wherein the data view comprises three dimensions.
